(19) United States
(12) Patent Application Publication
(10) Pub. No.: US 2025/0231657 A1
(43) Pub. Date: Jul. 17, 2025

(54) SYSTEM AND METHOD FOR WIDGET DISPLAY MANAGEMENT

(71) Applicant: Samsung Electronics Co., Ltd., Suwon-si (KR)

(72) Inventors: Sukumar MOHARANA, Bengaluru (IN); Debi Prasanna MOHANTY, Bengaluru (IN); Kadaru SAI RAVI TEJA, Bengaluru (IN); Anchal PANDEY, Bengaluru (IN); Ishaan NEJEEB, Bengaluru (IN); Latika JINDAL, Bengaluru (IN); Vanraj VALA, Bengaluru (IN); Siva Prasad THOTA, Bengaluru (IN); Dwaraka Bhamidipati SREEVATSA, Bengaluru (IN); Gopi RAMENA, Bengaluru (IN)

(21) Appl. No.: 19/025,025

(22) Filed: Jan. 16, 2025

Related U.S. Application Data
(63) Continuation of application No. PCT/KR2024/020203, filed on Dec. 10, 2024.

(30) Foreign Application Priority Data
Jan. 15, 2024 (IN) 202441002956

(51) Int. Cl. G06F 3/0481; G06F 9/451

(52) U.S. Cl. CPC G06F 3/0481; G06F 9/451

(57) ABSTRACT

A system and a method for widget display management on a wallpaper on a user equipment (UE) are provided. The method includes detecting at least one of a current display position and a current style of at least one widget displayed on the wallpaper, detecting one or more objects present in a plurality of regions of the wallpaper, estimating one or more changes required in the at least one widget based on at least one of the current display position and the current style, and further based on the one or more objects, and altering, based on the estimated one or more changes, at least one of the current display position and the current style of the at least one widget.

### CROSS-REFERENCE TO RELATED APPLICATION(S)

This application is a continuation application, claiming priority under § 365 (c), of an International application No. PCT/KR2024/020203, filed on Dec. 10, 2024, which is based on and claims the benefit of an Indian Patent Application number 202441002956, filed on Jan. 15, 2024, in the Indian Patent Office, the disclosure of which is incorporated by reference herein in its entirety.

### TECHNICAL FIELD

The disclosure relates to the field of managing widget displays. More particularly, the disclosure relates to a method and a system for widget display management on a wallpaper displayed on a user equipment (UE).

### BACKGROUND ART

As technology and design patterns evolve, there is a constant drive to enhance user interfaces (UIs) to be visually engaging and immersive. One area of focus is widget placement within the UIs. Various solutions have been provided to determine the optimal positioning of widgets to maximize usability, visual appeal, and user engagement. One of the existing approaches is depth-based widget placement.

The above information is presented as background information only to assist with an understanding of the disclosure. No determination has been made, and no assertion is made, as to whether any of the above might be applicable as prior art with regard to the disclosure.

### DISCLOSURE

### Technical Solution

Aspects of the disclosure are to address at least the above-mentioned problems and/or disadvantages and to provide at least the advantages described below. Accordingly, an aspect of the disclosure is to provide a method and a system for widget display management on a wallpaper displayed on a user equipment (UE).

Additional aspects will be set forth in part in the description which follows and, in part, will be apparent from the description, or may be learned by practice of the presented embodiments.

In accordance with an aspect of the disclosure, a method for widget display management on a wallpaper on a user equipment is provided. The method includes detecting at least one of a current display position and a current style of at least one widget displayed on the wallpaper, detecting one or more objects present in a plurality of regions of the wallpaper, estimating one or more changes required in the at least one widget based on at least one of the current display position and the current style, and further based on the one or more objects, and altering, based on the estimated one or more changes, at least one of the current display position and the current style of the at least one widget.

In accordance with another aspect of the disclosure, a system for widget display management on a wallpaper on a user equipment (UE) is provided. The system includes memory storing one or more computer programs, and one or more processors communicatively coupled to the memory, wherein the one or more computer programs include computer-executable instructions that, when executed by the one or more processors individually or collectively, cause the system to detect at least one of a current display position and a current style of at least one widget displayed on the wallpaper, detect one or more objects present in a plurality of regions of the wallpaper, estimate one or more changes required in the at least one widget based on at least one of the current display position and the current style, and further based on the one or more objects, and alter, based on the estimated one or more changes, at least one of the current display position and the current style of the at least one widget.

In accordance with another aspect of the disclosure, one or more non-transitory computer-readable storage media storing one or more computer programs including computer-executable instructions that, when executed by one or more processors of an electronic device individually or collectively, cause the electronic device to perform operations is provided. The operations include detecting at least one of a current display position and a current style of at least one widget displayed on a wallpaper, detecting one or more objects present in a plurality of regions of the wallpaper, estimating one or more changes required in the at least one widget based on at least one of the current display position and the current style, and further based on the one or more objects, and altering, based on the estimated one or more changes, at least one of the current display position and the current style of the at least one widget.

Other aspects, advantages, and salient features of the disclosure, will become apparent to those skilled in the art from the following detailed description, which, taken in conjunction with the annexed drawings discloses various embodiments of the disclosure.

### DESCRIPTION OF DRAWINGS

The above and other aspects, features, and advantages of certain embodiments of the disclosure will be more apparent from the following description taken in conjunction with the accompanying drawings, in which:

FIGS. 1A and 1B illustrate pictorial diagrams depicting a problem associated with a solution for widget placement, according to the related art;

FIG. 2 illustrates a pictorial diagram depicting the displaying of widgets using the existing techniques according to the related art;

FIGS. 3A and 3B illustrate pictorial diagrams depicting display of a widget, according to various embodiments of the disclosure;

FIG. 4 illustrates a block diagram depicting a system for widget display management, according to an embodiment of the disclosure;

FIG. 5 illustrates a block diagram depicting the modules(s) the system for widget display management, according to an embodiment of the disclosure;

FIG. 6 illustrates a flow diagram depicting an operation flow of a system for widget display management, according to an embodiment of the disclosure;

FIG. 7 illustrates a schematic diagram depicting a scene graph determination by the scene understanding module, according to an embodiment of the disclosure;

FIG. 8 illustrates a pictorial diagram depicting a composition property map, according to an embodiment of the disclosure;

FIG. 9A illustrates a flow diagram depicting a flow of operations for determining relevant objects, according to an embodiment of the disclosure;

FIG. 9B illustrates a pictorial diagram depicting determination of attention score, according to an embodiment of the disclosure;

FIG. 9C illustrates a pictorial diagram depicting determination of scene graph relevance score, according to an embodiment of the disclosure;

FIG. 9D illustrates a pictorial diagram depicting an implementation of the altered widget generation module, according to an embodiment of the disclosure;

FIG. 10 illustrates a pictorial diagram depicting an altered widget, according to an embodiment of the disclosure; and

FIGS. 11A and 11B illustrate a flow diagram depicting the method for widget display management, according to various embodiments of the disclosure.

Throughout the drawings, it should be noted that like reference numbers are used to depict the same or similar elements, features, and structures.

### MODE FOR INVENTION

The following description with reference to the accompanying drawings is provided to assist in a comprehensive understanding of various embodiments of the disclosure as defined by the claims and their equivalents. It includes various specific details to assist in that understanding, but these are to be regarded as merely exemplary. Accordingly, those of ordinary skill in the art will recognize that various changes and modifications of the various embodiments described herein can be made without departing from the scope and spirit of the disclosure. In addition, descriptions of well-known functions and constructions may be omitted for clarity and conciseness.

The terms and words used in the following description and claims are not limited to the bibliographical meanings, but are merely used by the inventor to enable a clear and consistent understanding of the disclosure. Accordingly, it should be apparent to those skilled in the art that the following description of various embodiments of the disclosure is provided for illustration purposes only and not for the purpose of limiting the disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

Reference throughout this specification to “an aspect”, “another aspect” or similar language means that a particular feature, structure, or characteristic described in connection with the embodiment is included in at least one embodiment of the disclosure. Thus, appearances of the phrase “in an embodiment”, “in another embodiment” and similar language throughout this specification may, but do not necessarily, all refer to the same embodiment.

It is to be understood that as used herein, terms such as, “includes,” “comprises,” “has,” etc. are intended to mean that the one or more features or elements listed are within the element being defined, but the element is not necessarily limited to the listed features and elements, and that additional features and elements may be within the meaning of the element being defined. In contrast, terms such as, “consisting of” are intended to exclude features and elements that have not been listed.

The embodiments herein and the various features and advantageous details thereof are explained more fully with reference to the non-limiting embodiments that are illustrated in the accompanying drawings and detailed in the following description. Descriptions of well-known components and processing techniques are omitted to not unnecessarily obscure the embodiments herein. Also, the various embodiments described herein are not necessarily mutually exclusive, as some embodiments can be combined with one or more other embodiments to form new embodiments. The term “or” as used herein, refers to a non-exclusive or unless otherwise indicated. The examples used herein are intended merely to facilitate an understanding of ways in which the embodiments herein can be practiced and to further enable those skilled in the art to practice the embodiments herein. Accordingly, the examples should not be construed as limiting the scope of the embodiments herein.

As is traditional in the field, embodiments may be described and illustrated in terms of blocks that carry out a described function or functions. These blocks, which may be referred to herein as units or modules or the like, are physically implemented by analog or digital circuits such as logic gates, integrated circuits, microprocessors, microcontrollers, memory circuits, passive electronic components, active electronic components, optical components, hardwired circuits, or the like, and may optionally be driven by firmware and software. The circuits may, for example, be embodied in one or more semiconductor chips, or on substrate supports such as printed circuit boards and the like. The circuits constituting a block may be implemented by dedicated hardware, by a processor (e.g., one or more programmed microprocessors and associated circuitry), or by a combination of dedicated hardware to perform some functions of the block and a processor to perform other functions of the block. Each block of the embodiments may be physically separated into two or more interacting and discrete blocks without departing from the scope of the disclosure. Likewise, the blocks of the embodiments may be physically combined into more complex blocks without departing from the scope of the disclosure.

The accompanying drawings are used to help easily understand various technical features and it should be understood that the embodiments presented herein are not limited by the accompanying drawings. As such, the disclosure should be construed to extend to any alterations, equivalents, and substitutes in addition to those which are particularly set out in the accompanying drawings. Although the terms first, second, etc. may be used herein to describe various elements, these elements should not be limited by these terms. These terms are generally only used to distinguish one element from another.

It should be appreciated that the blocks in each flowchart and combinations of the flowcharts may be performed by one or more computer programs which include instructions. The entirety of the one or more computer programs may be stored in a single memory device or the one or more computer programs may be divided with different portions stored in different multiple memory devices.

Any of the functions or operations described herein can be processed by one processor or a combination of processors. The one processor or the combination of processors is circuitry performing processing and includes circuitry like an application processor (AP, e.g. a central processing unit (CPU)), a communication processor (CP, e.g., a modem), a graphics processing unit (GPU), a neural processing unit (NPU) (e.g., an artificial intelligence (AI) chip), a Wi-Fi chip, a Bluetooth® chip, a global positioning system (GPS) chip, a near field communication (NFC) chip, connectivity chips, a sensor controller, a touch controller, a finger-print sensor controller, a display driver integrated circuit (IC), an audio CODEC chip, a universal serial bus (USB) controller, a camera controller, an image processing IC, a microprocessor unit (MPU), a system on chip (SoC), an IC, or the like.

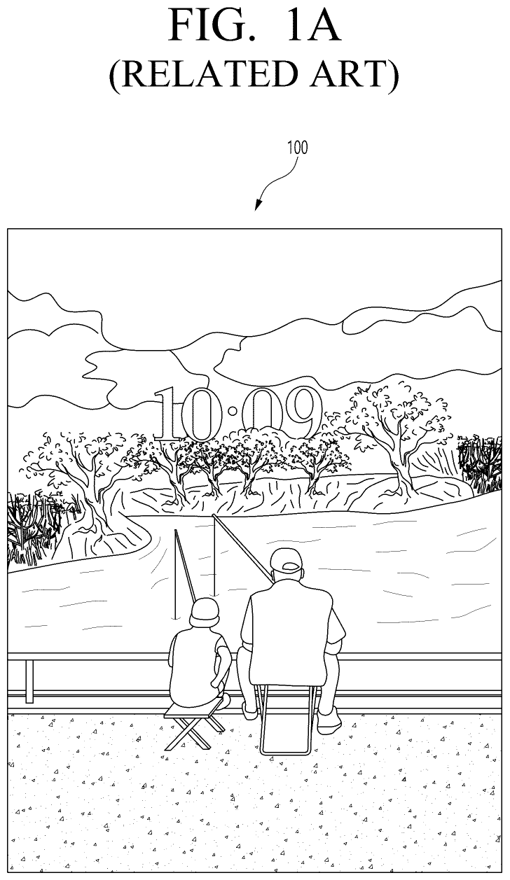

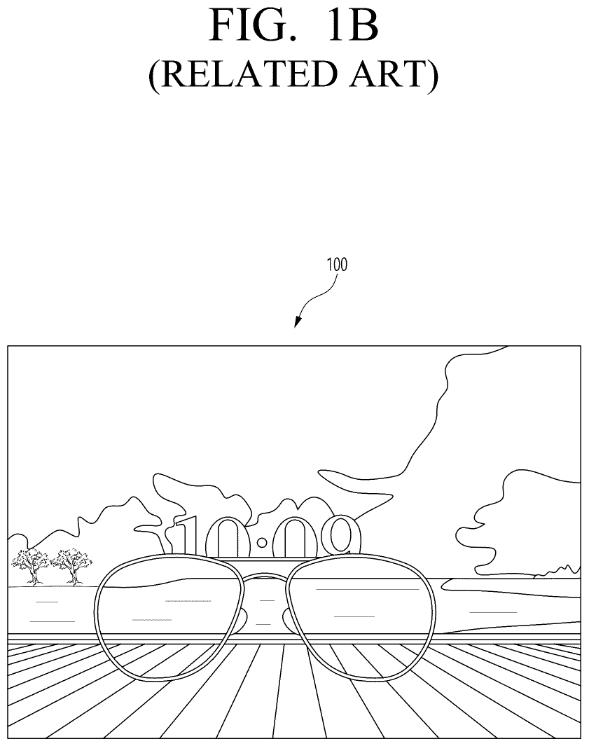

FIGS. 1A and 1B illustrate pictorial diagrams depicting a problem associated with an existing solution for widget placement, according to the related art.

Referring to FIGS. 1A and 1B, the depth-based widget placement techniques according to the related art often fail to consider the perceived depth of content and the surrounding elements, resulting in widgets that may appear disjointed or obstructed. For example, FIG. 1A depicts an image 100 where two people are fishing by a lake and the farther lakeside is full of green trees. As shown in the figure, a widget (such as a time widget), when overlaid on the image using depth-based widget placement approach, goes behind the trees. The widget does not blend well with the elements of the image, making the widget look unappealing. Further, even a complete view of the widget is obstructed. A similar issue can also be viewed in an image 100 depicted in FIG. 1B, where a pair of sunglasses can be seen lying on a beach deck. The time widget, when overlaid using the depth-based widget placement approach goes behind the pair of sunglasses. The view of the time widget is obstructed and the time widget appears disjoint from the image. Thus, the existing approaches pose additional challenges resulting in unappealing placement of widgets.

Accordingly, there lies a need for an improved solution that can address the above-discussed problems.

As described earlier, existing techniques for widget display lack scene awareness while overlaying a widget on a given wallpaper. More specifically, there is an absence of correlation between the widget and the wallpaper. Such techniques often rely on fixed positioning of the widget, thereby limiting the adaptivity of the widget to different scenes.

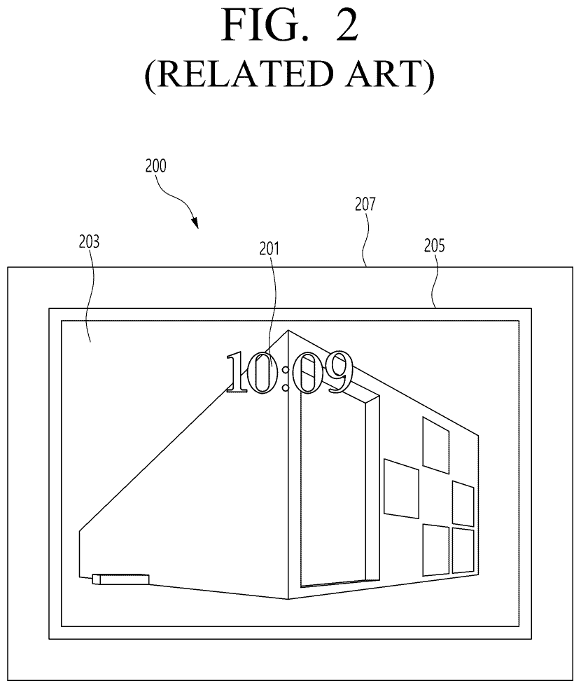

FIG. 2 illustrates a pictorial diagram 200 depicting the displaying of widgets according to the related art.

Referring to FIG. 2, widget 201 may be overlaid on image 203 of a building displayed as a wallpaper on display 205 of a user device 207. The widget 201 appears to have been placed at a fixed position without appearing to be a part of the scene depicted in the image 203. In these solutions, there has been progress towards making widget positioning more dynamic. However, even such approaches lack scene awareness.

An object of the disclosure is to address the above-described limitations by providing techniques for displaying widget(s) on a wallpaper in such a manner that the widgets appear blended in and contextually aware with respect to the scene depicted in the wallpaper. According to the embodiments of the disclosure, the wallpaper may be a visual media of a user's preference. In an embodiment, the visual media may be an image or a video.

The disclosure achieves the above-mentioned objective by providing a system and a method for widget display management. With respect to the disclosed system and method, described herein is a technique to make widgets scene aware to enhance the user experience and improve the immersive nature of the composition of the wallpaper and the widget.

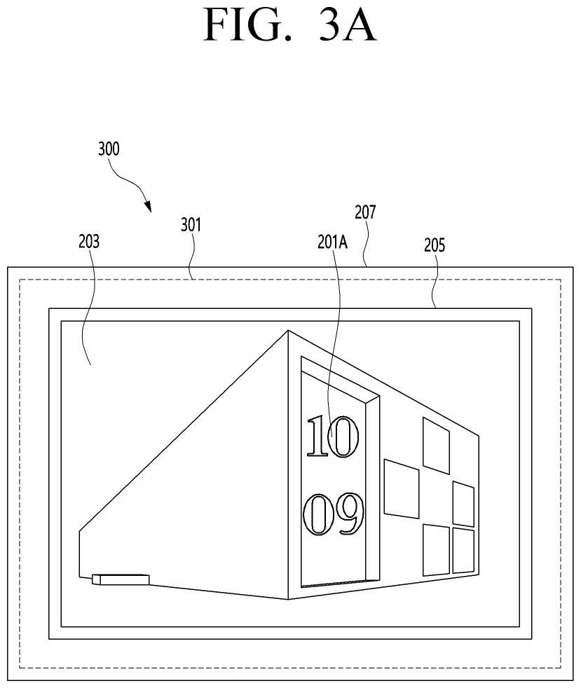

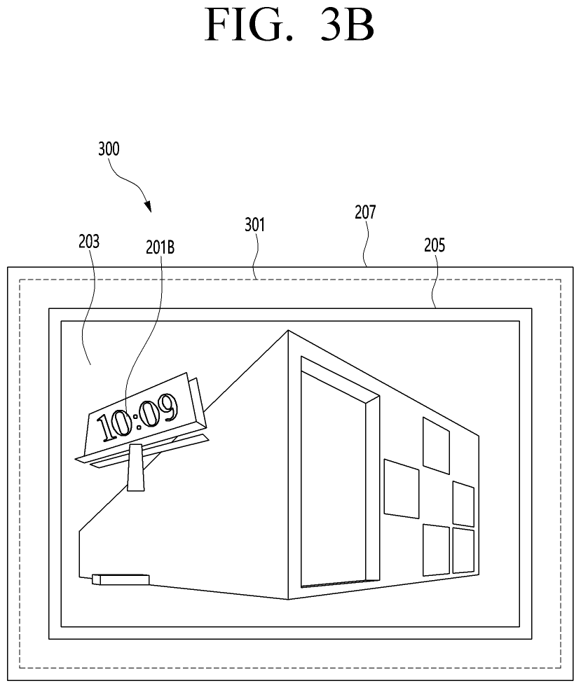

A display of the widget 201 on the user device 207 and in accordance with the described technique is depicted in FIGS. 3A and 3B. While the examples used herein depict only one widget, it should be noted that the present technique can be implemented on multiple widgets that may be present on the wallpaper.

FIGS. 3A and 3B illustrate pictorial diagrams 300 depicting a display of a widget, according to various embodiments of the disclosure.

Referring to FIG. 3A, when the user device 207 includes a system 301 for widget display management, the widget 201 may be altered to appear as widget 201A. The widget 201A may be displayed on the wallpaper of the image 203 in such a manner that the widget 201A appears to be a giant banner hanging from the building shown in the image 203. In another outcome depicted in FIG. 3B, the widget 201 may be altered to appear as widget 201B. The altered widget 201B may be displayed on the image 203 in such a manner that the widget 201B appears to be a banner displayed on a billboard pole installed near the building shown in the image 203.

A detailed methodology is explained in the following paragraphs of the disclosure.

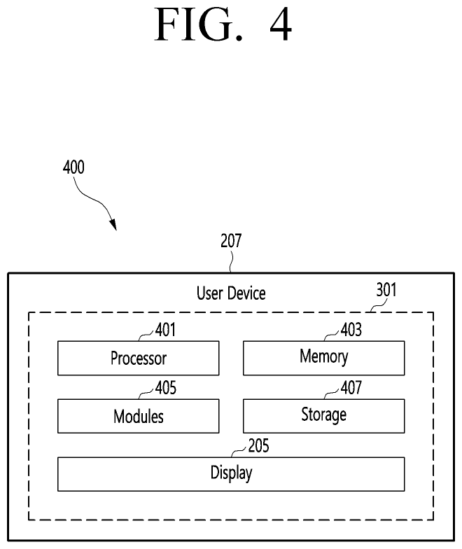

FIG. 4 illustrates a block diagram 400 depicting a system 301 for widget display management, according to an embodiment of the disclosure.

Referring to FIG. 4, the system 301 is configured to implement a method for widget display management in the user device 207. The user device 207 may be various types of devices such as, but not limited to, a personal digital assistant (PDA), electronic frame, electronic book, electronic notepad, motion picture experts group (MPEG)-2 audio layer III (MP3) player, tablet personal computer (PC), laptop computer, monitor, kiosk, or tablet PC.

The system 301 includes a processor(s) 401, memory 403, module(s) 405, a storage 407, and the display 205 coupled with each other.

The processor 401 may be a single processing unit or a number of units, all of which could include multiple computing units. The processor 401 may be implemented as one or more microprocessors, microcomputers, microcontrollers, digital signal processors, central processing units, logical processors, virtual processors, state machines, logic circuitries, and/or any devices that manipulate signals based on operational instructions. Among other capabilities, the processor 401 may be configured to fetch and execute computer-readable instructions and data stored in the memory 403.

The memory 403 may include any non-transitory computer-readable medium known in the art including, for example, volatile memory, such as static random access memory (SRAM) and dynamic random access memory (DRAM), and/or non-volatile memory, such as read-only memory (ROM), erasable programmable ROM, flash memories, hard disks, optical disks, and magnetic tapes.

The module(s) 405 may include a program, a subroutine, a portion of a program, a software component, or a hardware component capable of performing one or more of functions, as discussed throughout the disclosure. As used herein, the module(s) 405 may be implemented on a hardware component such as a server independently of other modules, or a module can exist with other modules on the same server, or within the same program. The module(s) 405 may be implemented on a hardware component such as processor one or more microprocessors, microcomputers, microcontrollers, digital signal processors, central processing units, state machines, logic circuitries, and/or any devices that manipulate signals based on operational instructions. The module(s) 405 when executed by the processor(s) 401 may be configured to perform any of the functionalities described herein.

The storage 407 may be implemented with integrated hardware and software. The hardware may include a hardware disk controller with programmable search capabilities or a software system running on general-purpose hardware. The examples of storage 407 may include, but are not limited to, in-memory databases, cloud databases, distributed databases, embedded databases, and the like. The storage 407, amongst other things, serves as a repository for storing data processed, received, and generated by one or more of the processors, and the modules/engines/units.

The module(s) 405 may be implemented using one or more AI modules that may include a plurality of neural network layers. Examples of neural networks include, but are not limited to, Convolutional Neural Network (CNN), Deep Neural Network (DNN), Recurrent Neural Network (RNN), and Restricted Boltzmann Machine (RBM). According to some embodiments, the module(s) 405 may be implemented using one or more generative AI modules that may include Variational Autoencoders (VAEs), Generative Adversarial Networks (GANs), flow-based generative model, auto-regressive models and the like. Further, ‘learning’ may be referred to in the disclosure as a method for training a predetermined target device (for example, a robot) using a plurality of learning data to cause, allow, or control the target device to make a determination or prediction. Examples of learning techniques include but are not limited to supervised learning, unsupervised learning, semi-supervised learning, or reinforcement learning. At least one of a plurality of CNN, DNN, RNN, RMB, VAES, GANs, flow-based generative model, auto-regressive models and the like may be implemented to thereby achieve execution of the present subject matter's mechanism through an AI model or a generative AI model. A function associated with an AI module or the generative AI models may be performed through the non-volatile memory, the volatile memory, and the processor. The processor may include one or a plurality of processors. The one or more processors may be a general-purpose processor, such as a central processing unit (CPU), an application processor (AP), or the like, a graphics-only processing unit such as a graphics processing unit (GPU), a visual processing unit (VPU), and/or an AI-dedicated processor such as a neural processing unit (NPU). One or a plurality of processors or neural processors control the processing of the input data in accordance with a predefined operating rule or an artificial intelligence (AI) model or a generative AI model stored in the non-volatile memory and the volatile memory. The predefined operating rule or artificial intelligence model is provided through training or learning.

The display 205 may be configured to display a wallpaper on the user device 207 and at least one widget on the wallpaper. The display 205 may include may include various types of display panels such as a Liquid Crystal Display (LCD), an organic light-emitting diode (OLED), an electrophoretic display (EPD), an electrochromic display (ECD), and a plasma display panel (PDP).

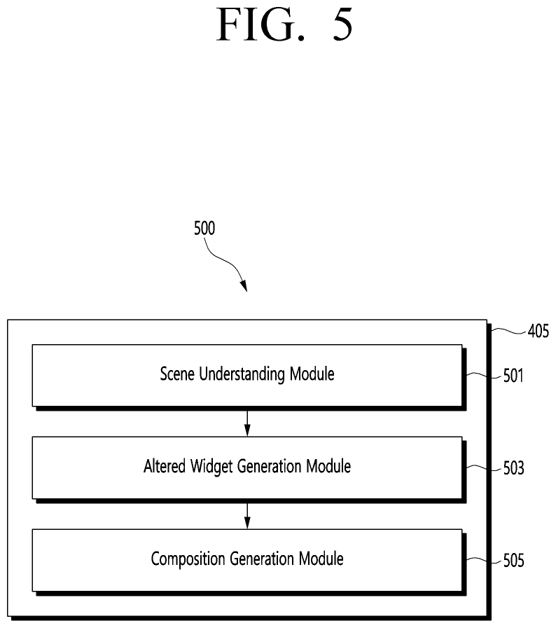

The module(s) 405 are now described below in conjunction with FIGS. 5 to 8, 9A to 9D, and 10.

FIG. 5 illustrates a block diagram depicting modules(s) of a system for widget display management, according to an embodiment of the disclosure.

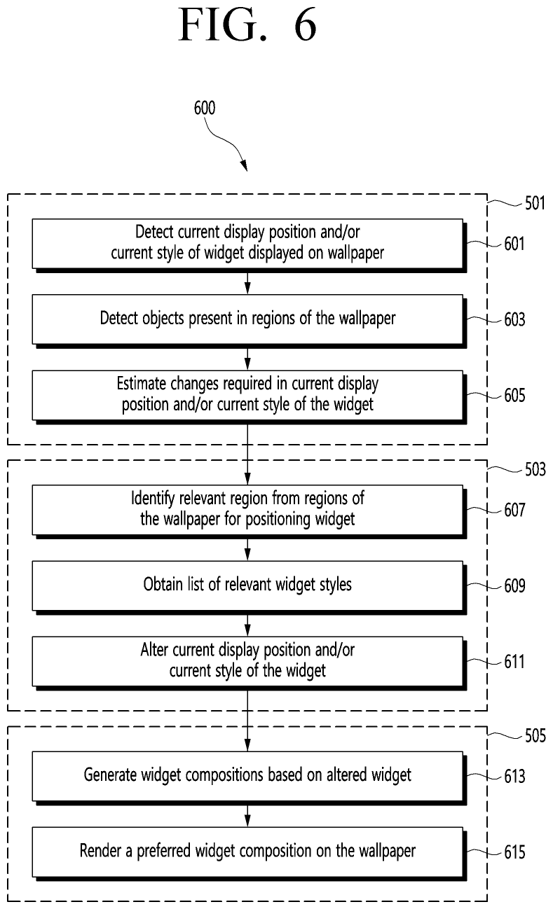

FIG. 6 illustrates a flow diagram depicting an operation flow of a system 301 for widget display management, according to an embodiment of the disclosure.

Referring to FIGS. 5 and 6, an explanation of the operation flow 600 will be explained in the forthcoming paragraphs. The reference numerals have been kept the same for the similar components throughout the disclosure for ease of explanation and understanding.

The module(s) 405 may include a scene understanding module 501, an altered widget generation module 503, and a composition generation module 505.

Initially, at operation 601, for a given widget 201 overlaid on a wallpaper, at least one of a current display positions and a current style of the widget 201 is detected. Visual media (e.g., the image 203) may be displayed as wallpaper on the user device 207. The current display position refers to a specific location on the display 205 where the widget is currently situated. A style of a widget refers to the visual appearance and formatting characteristics of the widget. Such characteristics may include attributes including, but not limited to, color, size, font, or any attribute related to visual appearance that defines how the widget appears on the display 205. Accordingly, the current style of the widget 201 refers to the current visual appearance and formatting characteristics of the widget 201.

At operation 603, one or more objects present in a plurality of regions of the wallpaper (i.e., the image 203 in the present example) are detected by generating a scene graph associated with the scene depicted in the image 203. For example, in the image 203, the sky and road may correspond to the plurality of regions, while the building may correspond to an object in the plurality of regions.

At operation 605, one or more changes required in the widget 201 are estimated based at least on the detected current display position, and the current style. The one or more changes required may be based on the detected one or more objects in the plurality of regions of the wallpaper (image 203). The scene understanding module 501 is described in greater detail below.

The altered widget generation module 503 may alter at least one of the current display position and the current style of the widget 201 based on the estimated one or more required changes to generate at least one altered widget. The at least one altered widget may correspond to widgets 201A and 201B as depicted in FIG. 2. At operation 607, in response to estimating the one or more required changes, the altered widget generation module 503 identifies at least one relevant region from the plurality of regions for positioning the widget 201.

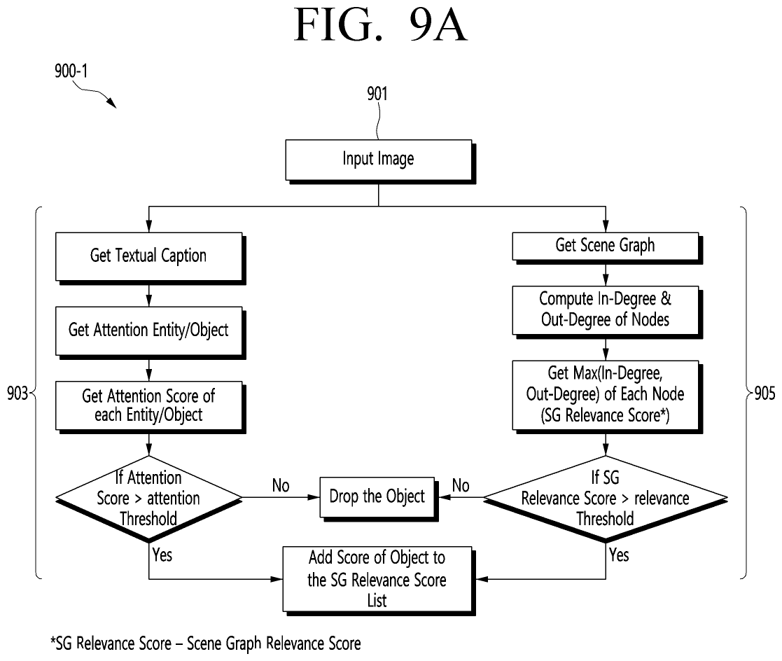

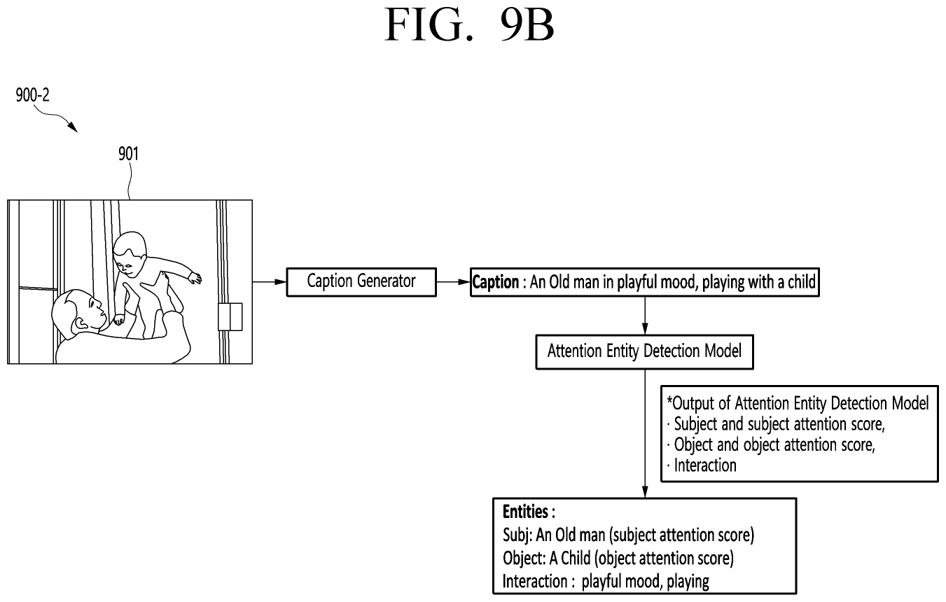

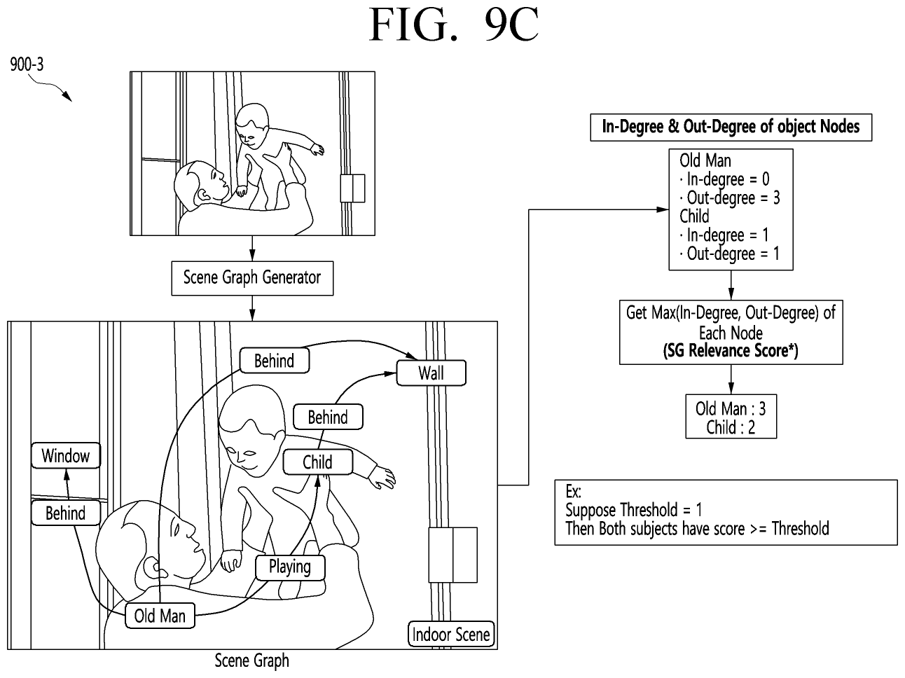

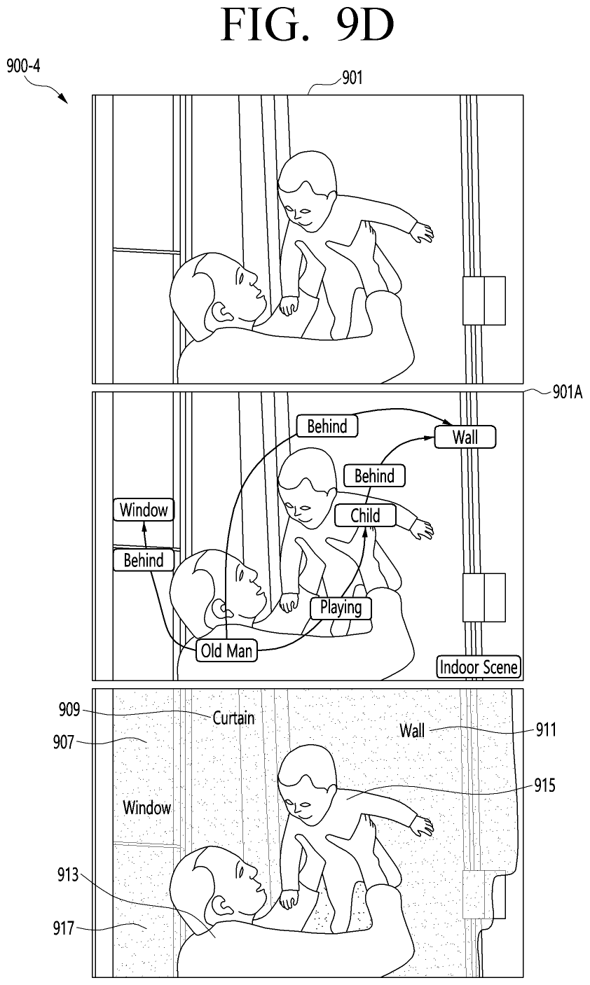

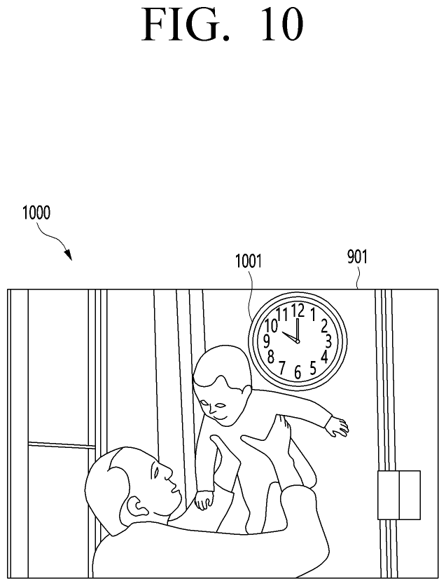

At operation 609, based on the identified at least one relevant region, the altered widget generation module 503 obtains a list of relevant widget styles based on corresponding one or more properties of the at least one relevant region. The widget 201 may be modified by altering at least one of the current display position and the current style of the widget 201. At operation 611, the altered widget generation module 503 generates at least one altered widget, such that the at least one altered widget is defined by at least one of an altered display position and an altered style. The altered display position may refer to the at least one relevant region. The altered style may be determined based on one of the obtained list of relevant widget styles and the corresponding one or more properties of the at least one relevant region. The altered widget generation module 503 is described below in greater detail in the following paragraphs/in conjunction with FIGS. 9A, 9B, 9C, 9D, and 10.

At operation 613, the composition generation module 505 generates one or more widget compositions based on the at least one altered widget, the at least one relevant region, and the corresponding one or more properties associated with the at least one relevant region. The composition generation module 505 is described below in greater detail in the following paragraphs.

At operation 615, the composition generation module 505 renders the wallpaper by positioning a preferred widget composition on the wallpaper. According to an embodiment of the disclosure, the user may select the preferred widget composition from at least one widget composition generated by the composition generation module 505.

The various module(s) 405 are described in greater detail below.

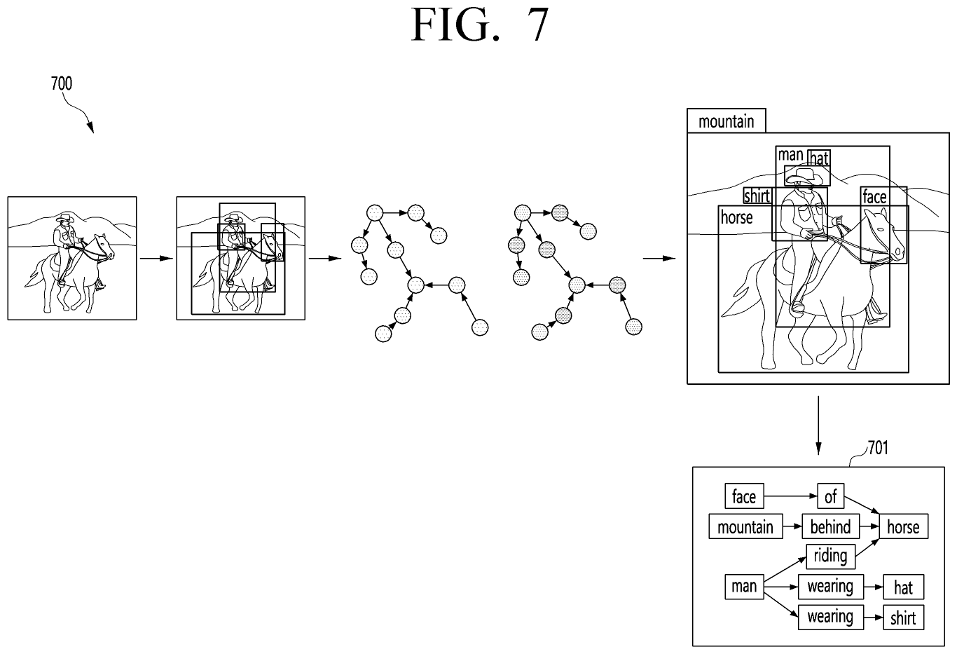

The scene understanding module 501 may be configured to detect the current display position of the widget 201 and the current style of the widget 201. The scene understanding module 501 may also be configured to detect one or more objects present in the plurality of regions of the wallpaper (i.e., the image 203). To detect the one or more objects, the scene understanding module 501 may generate a scene graph associated with the scene depicted in the image 203, as depicted in FIG. 7.

FIG. 7 illustrates a schematic diagram 700 depicting a scene graph determination by a scene understanding module according to an embodiment of the disclosure.

Referring to FIG. 7, the scene graph represents the one or more objects present in the scene and a relationship among the one or more objects determined based on an interaction among the one or more objects. A scene graph is a hierarchical data structure used to represent the spatial and logical relationships between the one or more objects in the scene.

In the scene graph, the one or more objects are organized into a tree-like structure as shown in the figure, enabling an efficient understanding of the scene as depicted in block 701. Such understanding is essential for determining the relevance of additional objects within the scene that might be included. Further, the scene graph enables determining how the additional objects may interact with the existing objects in the scene.

The scene understanding module 501 may also determine a segmentation map and a depth map of the wallpaper (e.g., the image 203). The segmentation map may be determined using a predetermined segmentation model. According to an embodiment of the disclosure, the predetermined segmentation model may be a Segment Anything Model. The Segment Anything Model is a widely known and used tool for image segmentation. The model provides rich semantic category annotations using a semantic segment anything engine (SSA engine), enabling the generation of labeled segmentation maps for any given image. Consequently, the labeled segmentation maps provide accurate object detection and classification.

Furthermore, the depth map may be determined using a predetermined framework. In an embodiment, the predetermined framework may be a predefined neural network model-based spatial-channel multi-task prompting framework. The framework seamlessly combines the learning of task-specific and task-generic representations and facilitates cross-task interactions at each layer of the neural network within the entire architecture of the framework. The seamless combination is achieved by embedding task prompts and patch tokens into the neural network model.

The task prompts and patch tokens are components used within the spatial-channel multi-task prompting framework to guide and facilitate the learning of task-specific and task-generic representations in the neural network model. The task prompts are transformed into spatial task prompts and channel task prompts, enabling the neural network model to learn spatial and channel-wise interactions, which are crucial for generating dense predictions, such as depth maps.

Furthermore, the spatial and channel task prompts, along with the patch tokens, play a pivotal role in guiding the extraction of dense task-specific features and contribute to multi-task predictions. The multi-task predictions refer to the capability of the neural network model to simultaneously make predictions within a single model. For example, when a busy road scene is analyzed, the neural network model may simultaneously perform several related tasks based on an input image of the busy road scene. The several related tasks, in the context of the busy road scene analysis, may include object detection, lane detection, and depth estimation. Overall, the multi-task prediction capability of the spatial-channel multi-task prompting framework leverages shared information within the image (in the present example, the image of a busy road), such as the edges of objects, road markings, and the overall context of the scene, to provide a comprehensive understanding of the scene.

The scene understanding module 501 may be configured to estimate the one or more changes required in the widget based on at least one of the current display position of the widget 201, the current style of the widget 201, and the detected one or more objects. To estimate the one or more changes required, scene understanding module 501 may detect at least one of an overlap between the widget 201 and at least one of the one or more objects, and an absence of correlation between the widget 201 and the wallpaper.

The overlap may be caused by at least one of the current display position and the current style of the at least one widget. The absence of correlation between the at least one widget and the wallpaper may be detected with respect to one or more properties associated with the plurality of regions of the wallpaper. Finally, upon detection of at least one of the overlap or the absence of correlation, the one or more changes required in at least one of the current display position and the current style of the at least one widget are estimated.

The detected one or more objects in the scene depicted in the image 203, the determined relationship among the one or more objects, the determined segmentation map, and the depth map may be used to generate a composition property map. The composition property map may be used by the altered widget generation module 503 to identify the at least one relevant region from the plurality of regions of the wallpaper (image 203).

The composition property map may refer to the one or more properties of the plurality of regions of the wallpaper. For example, the composition property map may refer to one or more properties of the plurality of regions of the image 203. The one or more properties of the plurality of regions of the wallpaper may include material properties, structural properties, and scenic properties.

For a given wallpaper, such as image 203, the material properties refer to the physical characteristics of the plurality of regions. For example, the material properties describe physical characteristics such as, but not limited to, reflective surface, transparency, translucency, color, cold, hot, bright, darker, etc. Material properties of one or more objects present in the plurality of regions may define physical characteristics such as but are not limited to, surface, material, texture, color, size, and shape of the one or more objects. The physical characteristics related to surface of the one or more objects may describe whether the one or more objects are one of rough or smooth, shiny or dull, hard or soft, flexible or stiff, and the like.

The physical characteristics related to material of the one or more objects may describe the make of one or more objects such as, but are not limited to, wood, metal, plastic, stone, and glass. Accordingly, the physical characteristics related to the material of the one or more objects may include but are not limited to, non-reflective, reflective, translucent, transparent, color, cold, hot, bright, and dark.

The structural properties may refer to specifications of the plurality of regions. The specifications may describe how the one or more objects in the plurality of regions look like. The specification may further describe what are the one or more objects used for and what additional properties the one or more objects have in a real-world setting.

According to an embodiment of the disclosure, the structural properties may define specifications such as, building properties, for example shopping mall having a big hoarding or a banner. According to another embodiment of the disclosure, the specification may define road or street properties, such as a tapering road, lane markings including painted lines, arrows, or symbols. According to another embodiment of the disclosure, the specification may define sky properties, for example, clear blue sky or cloudy sky.

The scenic properties may refer to the dynamics of the scene depicted in the wallpaper (image 203) comprising the plurality of regions. The dynamics of the scene represent how the one or more objects interact in the scene. For example, a small shop on busy street, a shop on a lonely street, or an old man holding a kid in an indoor setting with a window and a curtain behind them.

As mentioned above, the composition property map is generated using the one or more objects, the relationship among the one or more objects, and a determination of a segmentation map and a depth map of the wallpaper. In an embodiment, the composition property map may resemble a segmentation map. However, unlike a segmentation map, the composition property map may include labels, that are not limited to, an object classification. In addition to the object classification, the composition property map may also capture labels associated with the one or more properties as described above.

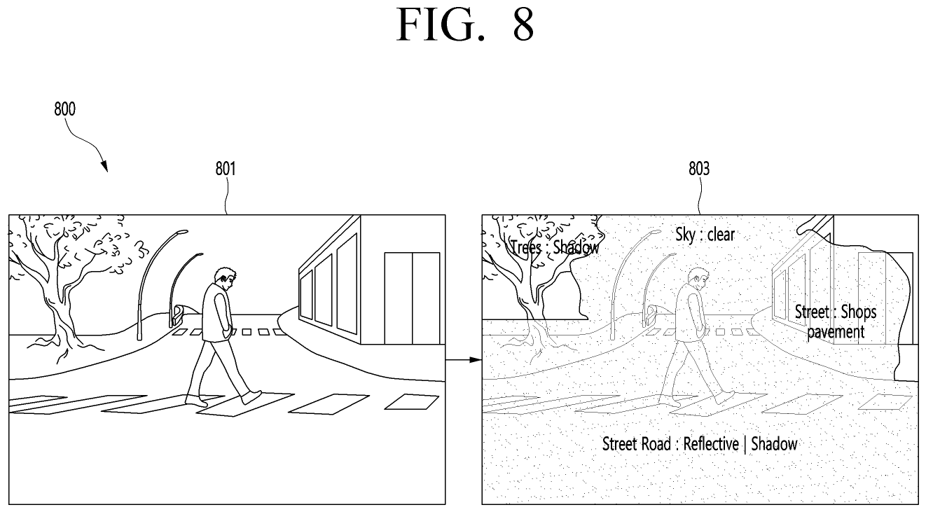

FIG. 8 illustrates a pictorial diagram 800 depicting a composition property map, according to an embodiment of the disclosure.

Referring to FIG. 8, for a given image 801, a composition property map 803 captures the objects within the scene depicted in the image 801 such as trees, sky, street, a man walking on the street (not shown), shop, and street road. In addition to these objects, the composition property map 803 also captures the properties including material, structural, and scenic properties such as shadows of trees, clear sky, shops and pavements on the street, and reflective street road with a shadow of the walking man.

A predetermined segmentation map estimation network may be implemented to generate the composition property map. For example, the segmentation map estimation network called SegVit may be implemented to generate the composition property map using the detection of one or more objects, the relationship among the one or more objects, and a determination of a segmentation map and a depth map of the wallpaper. The composition property map is used by the altered widget generation module 503 to identify one or more relevant regions from the plurality of regions of the wallpaper. The altered widget generation module 503 is described below in greater detail in conjunction with FIGS. 9A to 9D and 10.

FIG. 9A illustrates a flow diagram 900-1 depicting a flow of operations for determining relevant objects, according to an embodiment of the disclosure.

Referring to FIG. 9A, an input image 901 is processed by following at least two series of operations depicted by blocks 903 and 905. The series of operations depicted in block 903 describe determining attention score of each entity and object in the image 901 and are described in greater detail in FIG. 9B.

FIG. 9B illustrates a pictorial diagram 900-2 depicting determination of attention score, according to an embodiment of the disclosure.

Referring to FIG. 9B, the series of operations depicted in block 905 describe determining scene graph relevance score associated with the scene depicted in the image 901.

FIG. 9C illustrates a pictorial diagram 900-2 depicting determination of scene graph relevance score, according to an embodiment of the disclosure. FIGS. 9A, 9B, and 9C will now be described in conjunction with each other.

Referring to FIGS. 9A, 9B, and 9C, as shown in the series of operations 903, a textual caption describing the scene depicted in the image 901 is obtained using a caption generator. For example, referring to FIG. 9B, for the input image 901, a caption may be generated by the caption generator, “an Old man in playful mood, playing with a child”. Thereafter, the attention score for each entity and object identified in the image 901 is determined using a predetermined attention entity detection model. the attention entity detection model results in determination of entity and entity attention score, object and object attention score, interaction between the entity and the object. For example, for the caption generated above, the attention entity detection model may result in determining entity as an old man and corresponding attention score. The model may also determine object as a child and corresponding object attention score. If the attention score of the entity or the object is lower than predefined attention threshold, then the corresponding entity or the object is dropped. If the attention score the entity or the object is greater than predefined attention threshold, then the corresponding score of the corresponding entity or the object may be added to a scene graph relevance score list. Finally, the model may determine the interaction as playful mood, playing.

As shown in the series of operations 905, a scene graph (or the composition property map) associated with the scene depicted in the image 901 may be generated by a predetermined scene graph generator. Thereafter, a total number of in-degree and a total number of out-degree for each node in the scene graph is computed. For example, referring to FIG. 9C, the total number of in-degree for the node denoting ‘old man’ is 0, while the total number of out-degree for the node denoting ‘old man’ is 3. Similarly, the total number of in-degree for the node denoting ‘child is 1, and total number of in-degree for the node denoting ‘child’ is 1. Thereafter, a maximum of the in-degree and the out-degree of each node is determined. A scene graph relevance score may be determined based on the determined maximum of the in-degree and the out-degree of each node. For example, the scene graph relevance score for ‘old man’ is 3, and the scene graph relevance score for ‘child’ is 2. If the scene graph relevance score of the entity or the object is lower than a predefined relevance threshold, then the corresponding entity or the object is dropped. If the scene graph relevance score of the entity or the object is greater than the predefined relevance threshold, then the corresponding scene graph relevance score of the corresponding entity or the object may be added to a scene graph relevance score list.

FIG. 9D illustrates a pictorial diagram 900-4 depicting an implementation of an altered widget generation module, according to an embodiment of the disclosure.

Referring to FIG. 9D, the altered widget generation module 503 is configured to identify one or more relevant regions from the plurality of regions of the wallpaper (e.g., image 901) to position the widget 201 based on a size of the plurality of regions, a relevance of the plurality of regions, and the composition property map 901A associated with the plurality of regions of the wallpaper.

To identify the one or more relevant regions, the altered widget generation module 503 determines a set of contiguous regions from the plurality of regions based on segmentation information associated with the segmentation map and depth information associated with the depth map of the wallpaper. For example, in the image 901, window 907, curtain 909, and wall 911 may be identified as contiguous regions.

Further, the altered widget generation module 503 determines a relevancy score of each region of the set of contiguous regions 907, 909, 911 based on the one or more objects (an old man 913, a child 915, and the window glass 917) and the set of contiguous regions 907, 909, 911.

The at least one relevant object may refer to either the largest object or the most important object in the scene. The at least one relevant object may be determined based on a textual caption and relevance score associated with the scene depicted in the image 901. For example, in FIG. 9D, the old man 913, and the child 915 may be identified as relevant objects.

The relevancy score may be determined by identifying at least one relevant object 913, 915 from the one or more objects 913, 915, 917. In particular, the relevancy score is determined by computing an intersection over union between the at least one relevant object and each region of the set of contiguous regions.

One or more candidate regions may be identified from the set of contiguous regions 907, 909, and 911 based on the determination of relevancy score. Initially, the contiguous regions 907, 909, and 911 may be sorted based on the size and relevancy score of each region of the set of contiguous regions. Thereafter, the one or more candidate regions are identified from the sorted set of contiguous regions such that the relevancy score of the identified one or more candidate regions is greater than a predefined relevancy threshold. For example, the sorted contiguous regions maybe 911, 909, or 907 based on the size and relevance score of each region. The curtain 909 and the wall 911 may qualify as the candidate regions.

The at least one relevant region may be identified from the one or more candidate regions 911, 909 based on a relationship among the one or more objects and the one or more candidate regions 911, 909. For example, the wall 911 may be identified as the at least one relevant region may be identified from the one or more candidate regions 911, 909. Thereafter, a list of relevant widget styles may be obtained by the altered widget generation module 503 based on corresponding one or more properties associated with the at least one relevant region.

The altered widget generation module 503 may be configured to obtain a list of relevant widget styles based on corresponding one or more properties of the identified at least one relevant region (the wall 911 in the present example). A relevant widget style may refer to an altered widget. The altered widget may include an altered display position, an altered style, or both.

The altered display position may refer to the at least one relevant region. The altered style may be determined based on one of the obtained list of relevant widget styles and the corresponding one or more properties associated with the at least one relevant region. The list of relevant widget styles may be obtained from a widget database stored in the storage 407. A non-limiting list of relevant widget styles is depicted below in Table I.

TABLE I

| Scene Type | Widget Style | Widget Positioning |
|---|---|---|
| Sky: Rainy Cloudy | Dark cloud font, | Sky |
| | cloudy widget | |
| Sky: Sunny Cloudy | Light cloud font, | Sky |
| | cloudy widget | |
| Street: Busy Shop | Street Signage | On the street side, |
| | | the footpath |
| Road: Highway, Tapered, | Road milestone | On the roadside |
| Landscape | Signage | |
| Indoor: Wall, curtain, old | Analog clock | On the wall |
| man, child | | |

FIG. 10 illustrates a pictorial diagram 1000 depicting an altered widget, according to an embodiment of the disclosure.

Referring to FIG. 10, the altered widget 1001 may be generated by altering at least one of the current display positions and the current style of a widget. The altered display position may correspond to the at least one relevant region. The altered style may be determined based on one of the list of relevant widget styles and the corresponding one or more properties associated with the at least one relevant region.

For example, for the image 901, an altered widget 1001 may appear as an analog clock, positioned on the wall 911. In this example, the analog clock appearance corresponds to the altered style of the altered widget 1001, and the corresponding position of the analog clock on the wall 911 corresponds to the altered position of the widget 1001. Thereafter, one or more widget compositions are generated by the composition generation module 505 based on the at least one altered widget.

The composition generation module 505 may be configured to generate one or more widget compositions based on the at least one altered widget, the at least one relevant region, and the corresponding one or more properties associated with the at least one relevant region.

Each of the one or more widget compositions may possess an aesthetic score. One widget composition may have a higher aesthetic score than the other. Further, a suitable widget composition may have the aesthetic score greater than a predefined aesthetic threshold. The aesthetic score of a composition may depend on various factors, including, but not limited to, a position of the altered widget, a size of the altered widget, the relevance of the altered widget, and the color scheme of both the scene and the altered widget. The aesthetic score may be evaluated to indicate an overall composition quality, in terms of aesthetic value, of a widget composition. In an embodiment, the aesthetic score may be evaluated using predefined techniques such as, but not limited to, widget composition assessment dataset (WCAD) and saliency-augmented multi-pattern pooling (SAMP) module.

In a scenario, one or more widget compositions may have aesthetic scores greater than the predefined aesthetic threshold. In such cases, the user may select a preferred widget composition. Thereafter, the preferred widget composition may be displayed on a wallpaper rendered on the display 205 of the user device 207.

The composition generation module 505 may render the wallpaper by positioning the preferred widget composition on the wallpaper. In an additional embodiment, the rendering module identifies the altered widget in the rendered wallpaper as an active component of the wallpaper, and the wallpaper as a static component of the wallpaper.

The active component may be configured to be refreshed when the content of the widget is required to be updated. For example, in the image 901, the altered widget 1001 may be recognized as the active component, while the rest of the components such as the wall 911, the curtain 909, the window 907, the old man 913, and the child 915 of the image 901 may be recognized as the static component.

According to another embodiment of the disclosure, the visual media displayed as wallpaper may be a video comprising one or more scenes. In such a scenario, the composition generation module 505 may be configured to determine a span associated with each of the one or more scenes and corresponding scene span distance. A predefined neural network (NN) based technique may be used for determining the span. The NN-based technique may be temporal span network video visual relation detection. Finally, the composition generation module 505 may determine to generate widget compositions for the video when the scene span distance is less than a predefined distance threshold. In an alternate embodiment, the composition module generation 505 may generate a pre-determined widget composition when the scene span is greater than the predefined distance threshold.

To generate the widget compositions for the video (rendered as wallpaper), the composition module generation 505 may generate the at least one widget composition for each frame of the video. Thereafter, the composition module generation 505 selects the highest occurring widget composition from the corresponding widget compositions associated with each frame of the video. Further, the composition module generation 505 determines a widget drift between one or more neighboring frames based on a difference between the coordinates of the center of the at least one altered widget in the consecutive frames.

Further, the widget drift is compared with a predefined drift threshold and modifies a position of the selected widget composition in a current frame based on the position of the selected widget composition in a previous neighboring frame, when the widget drift is greater than the predefined drift threshold. Finally, the selected widget composition is applied to each frame of the video when the widget drift is less than the predefined drift threshold.

In an additional embodiment, the techniques described in the disclosure may also be implemented in a visual see-through (VST) device. In such embodiment, wallpaper may be applied to the scene viewed through the VST device.

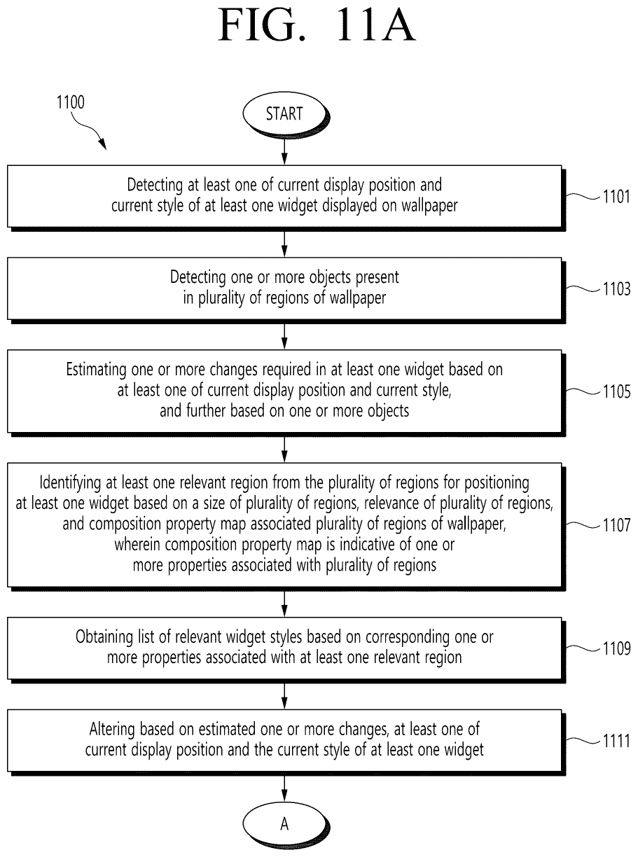

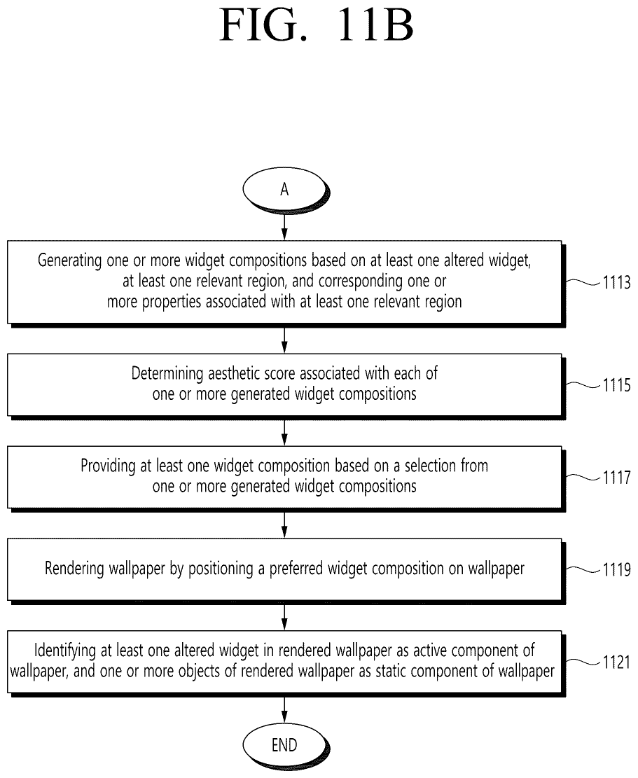

The disclosed method for widget display management is described below in conjunction with FIGS. 11A and 11B.

FIGS. 11A and 11B illustrate a flow diagram depicting a method for widget display management, according to various embodiments of the disclosure.

Referring to FIGS. 11A and 11B the method 1100 includes a series of operations 1101 through 1121 executed by one or more components of the system 301 of the user device 207, in particular the processor 401.

At operation 1101, the processor 401 detects at least one of a current display position and a current style of at least one widget displayed on the wallpaper device.

At operation 1103, the processor 401 detects one or more objects present in a plurality of regions of the wallpaper. The one or more objects are detected using a scene graph. The scene graph represents the one or more objects and a first relationship among the one or more objects determined based on an interaction among the one or more objects.

At operation 1105, the processor 401 estimates one or more changes required in the at least one widget based on at least one of the current display position and the current style, and further based on the one or more objects.

Estimating the one or more changes may comprise detecting at least one of an overlap between the at least one widget and at least one of the one or more objects, wherein the overlap is caused by at least one of the current display position and the current style of the at least one widget, and an absence of correlation between the at least one widget and the wallpaper (203) with respect to one or more properties associated with the plurality of regions of the 203, 901 (203, 901). Further, estimating the one or more changes comprises estimating, upon detection of the overlap and/or the absence of correlation, the one or more changes required in at least one of the current display position and the current style of the at least one widget.

At operation 1107, the processor 401 identifies at least one relevant region from the plurality of regions for positioning the at least one widget based on a size of the plurality of regions, a relevance of the plurality of regions, and a composition property map associated with the plurality of regions of the wallpaper, such that the composition property map is indicative of the one or more properties associated with the plurality of regions.

In an embodiment, the composition property map is generated based on the one or more objects, the first relationship among the one or more objects, and a determination of a segmentation map and a depth map of the wallpaper (203, 901).

In an embodiment, the one or more properties correspond to material properties associated with physical characteristics of the plurality of regions, structural properties associated with specification of the plurality of regions, and scenic properties associated with dynamics of a scene depicted in the wallpaper (203, 901) comprising the plurality of regions.

In an embodiment, for identifying the at least one relevant region, the processor 401 determines a set of contiguous regions from the plurality of regions based on the segmentation map and the depth map of the wallpaper (203, 901), determines a relevancy score of each region of the set of contiguous regions based on the one or more objects and the set of contiguous regions, identifies one or more candidate regions from the set of contiguous regions based on the segmentation map and the depth map, wherein the relevancy score of the one or more candidate regions is greater than a predefined relevancy threshold, and identifies the at least one relevant region from the one or more candidate regions based on a second relationship among the one or more objects and the one or more candidate regions

In an embodiment, determining the relevancy score comprises identifying at least one relevant object from the one or more objects, and determining the relevancy score based on intersection over union between the at least one relevant object and each region of the set of contiguous regions.

In an embodiment, identifying the at least one relevant object comprises determining textual caption and composition property map associated with the scene depicted in the wallpaper, and identifying the at least one relevant object based on the determined textual caption and composition property map.

At operation 1109, the processor 401 obtains a list of relevant widget styles based on corresponding one or more properties associated with the at least one relevant region.

At operation 1111, the processor 401 alters, based on the estimated one or more changes, at least one of the current display position and the current style of the at least one widget.

At operation 1113, the processor 401 generates one or more widget compositions based on the at least one altered widget, the at least one relevant region, and the corresponding one or more properties associated with the at least one relevant region.

At operation 1115, the processor 401 determines an aesthetic score associated with each of the one or more generated widget compositions.

At operation 1117, the processor 401 provides at least one widget composition based on a selection from the one or more generated widget compositions, wherein the aesthetic score associated with the at least one widget composition is greater than a predefined aesthetic threshold.

At operation 1119, the processor 401 renders the wallpaper by positioning a preferred widget composition on the wallpaper, wherein the preferred widget composition is selected by a user from the at least one widget composition.

At operation 1121, the processor 401 identifies the at least one altered widget in the rendered wallpaper as an active component of the wallpaper, and the one or more objects of the rendered wallpaper as static component of the wallpaper, such that the active component is refreshed when content of the widget is updated.

At least by virtue of aforesaid, the present subject matter at least provides the following advantages:

The method described herein generates widget composition by taking the material, scene, and structural properties of the wallpaper into account and uniquely defining the position and presentation of the widgets. Thereby, the described method enhances the user experience and improves the immersive nature of widget composition.

While specific language has been used to describe the present subject matter, any limitations arising on account thereto, are not intended. As would be apparent to a person in the art, various working modifications may be made to the method in order to implement the inventive concept as taught herein. The drawings and the foregoing description give examples of embodiments. Those skilled in the art will appreciate that one or more of the described elements may well be combined into a single functional element. Alternatively, certain elements may be split into multiple functional elements. Elements from one embodiment may be added to another embodiment.

It will be appreciated that various embodiments of the disclosure according to the claims and description in the specification can be realized in the form of hardware, software or a combination of hardware and software.

Any such software may be stored in non-transitory computer readable storage media. The non-transitory computer readable storage media store one or more computer programs (software modules), the one or more computer programs include computer-executable instructions that, when executed by one or more processors of an electronic device individually or collectively, cause the electronic device to perform a method of the disclosure.

Any such software may be stored in the form of volatile or non-volatile storage such as, for example, a storage device like read only memory (ROM), whether erasable or rewritable or not, or in the form of memory such as, for example, random access memory (RAM), memory chips, device or integrated circuits or on an optically or magnetically readable medium such as, for example, a compact disk (CD), digital versatile disc (DVD), magnetic disk or magnetic tape or the like. It will be appreciated that the storage devices and storage media are various embodiments of non-transitory machine-readable storage that are suitable for storing a computer program or computer programs comprising instructions that, when executed, implement various embodiments of the disclosure. Accordingly, various embodiments provide a program comprising code for implementing apparatus or a method as claimed in any one of the claims of this specification and a non-transitory machine-readable storage storing such a program.

While the disclosure has been shown and described with reference to various embodiments thereof, it will be understood by those skilled in the art that various changes in form and details may be made therein without departing from the spirit and scope of the disclosure as defined by the appended claims and their equivalents.

What is claimed is:

1. A method for widget display management on a wallpaper on a user equipment (UE), the method comprising:
detecting at least one of a current display position and a current style of at least one widget displayed on the wallpaper;
detecting one or more objects present in a plurality of regions of the wallpaper;
estimating one or more changes required in the at least one widget based on at least one of the current display position and the current style, and further based on the one or more objects; and
altering, based on the estimated one or more changes, at least one of the current display position and the current style of the at least one widget.

2. The method as claimed in claim 1, wherein estimating the one or more changes comprises:
detecting at least one of:
an overlap between the at least one widget and at least one of the one or more objects, wherein the overlap is caused by at least one of the current display position and the current style of the at least one widget, and
an absence of correlation between the at least one widget and the wallpaper with respect to one or more properties associated with the plurality of regions; and
estimating, upon detection of the overlap and/or the absence of correlation, the one or more changes required in at least one of the current display position and the current style of the at least one widget.

3. The method as claimed in claim 1,
wherein the one or more objects are detected using a scene graph, and
wherein the scene graph represents the one or more objects and a first relationship among the one or more objects determined based on an interaction among the one or more objects.

4. The method as claimed in claim 3, wherein, in response to estimating the one or more required changes, the method further comprises:
identifying at least one relevant region from the plurality of regions for positioning the at least one widget based on a size of the plurality of regions, a relevance of the plurality of regions, and a composition property map associated with the plurality of regions of the wallpaper, wherein the composition property map is indicative of the one or more properties associated with the plurality of regions; and
obtaining a list of relevant widget styles based on corresponding one or more properties associated with the at least one relevant region,
wherein the altering) comprises:
generating at least one altered widget,
wherein the at least one altered widget comprises at least one of an altered display position and an altered style,
wherein the altered display position corresponds to at the at least one relevant region, and
wherein the altered style is determined based on one of the obtained list of relevant widget styles and the corresponding one or more properties associated with the at least one relevant region.

5. The method as claimed in claim 4, wherein the composition property map is generated based on the one or more objects, the first relationship among the one or more objects, and a determination of a segmentation map and a depth map of the wallpaper.

6. The method as claimed in claim 4, wherein the one or more properties correspond to material properties associated with physical characteristics of the plurality of regions, structural properties associated with specification of the plurality of regions, and scenic properties associated with dynamics of a scene depicted in the wallpaper comprising the plurality of regions.

7. The method as claimed in claim 5, wherein identifying the at least one relevant region comprises:
determining a set of contiguous regions from the plurality of regions based on the segmentation map and the depth map of the wallpaper;
determining a relevancy score of each region of the set of contiguous regions based on the one or more objects and the set of contiguous regions;
identifying one or more candidate regions from the set of contiguous regions based on the segmentation map and the depth map, wherein the relevancy score of the one or more candidate regions is greater than a predefined relevancy threshold; and
identifying the at least one relevant region from the one or more candidate regions based on a second relationship among the one or more objects and the one or more candidate regions.

8. The method as claimed in claim 7, wherein determining the relevancy score comprises:
identifying at least one relevant object from the one or more objects; and
determining the relevancy score based on intersection over union between the at least one relevant object and each region of the set of contiguous regions.

9. The method as claimed in claim 8, wherein identifying the at least one relevant object comprises:
determining textual caption and composition property map associated with the scene depicted in the wallpaper; and
identifying the at least one relevant object based on the determined textual caption and composition property map.

10. The method as claimed in claim 4, further comprising:
generating one or more widget compositions based on the at least one altered widget, the at least one relevant region, and the corresponding one or more properties associated with the at least one relevant region;
determining an aesthetic score associated with each of the one or more generated widget compositions; and
providing at least one widget composition based on a selection from the one or more generated widget compositions, wherein the aesthetic score associated with the at least one widget composition is greater than a predefined aesthetic threshold.

11. The method as claimed in claim 10, further comprising:
rendering the wallpaper by positioning a preferred widget composition on the wallpaper, wherein the preferred widget composition is selected by a user from the at least one widget composition; and
identifying the at least one altered widget in the rendered wallpaper as an active component of the wallpaper, and the one or more objects of the rendered wallpaper as static component of the wallpaper, wherein the active component is refreshed when content of the widget is updated.

12. The method as claimed in claim 10,
wherein the wallpaper is a video comprising one or more scenes, and
wherein the method further comprises:
determining a span associated with each of the one or more scenes;
determining a scene span distance; and
determining to generate widget compositions for the video when the scene span distance is less than a predefined distance threshold.

13. The method as claimed in claim 12, further comprising generating a pre-determined widget composition when the scene span is greater than the predefined distance threshold.

14. The method as claimed in claim 12, further comprising:
generating the at least one widget composition for each frame of the video;
selecting a highest occurring widget composition from the corresponding widget compositions associated with each frame of the video;
determining a widget drift between one or more neighboring frames based on a difference between coordinates of the center of the at least one altered widget in consecutive frames;
comparing the widget drift with a predefined drift threshold;
modifying, when the widget drift is greater than the predefined drift threshold, a position of the selected widget composition in a current frame based on the position of the selected widget composition in a previous neighboring frame; and
applying the selected widget composition to each frame of the video when the widget drift is less than the predefined drift threshold.

15. A system for widget display management on a wallpaper on a user equipment (UE), the system comprising:
memory storing one or more computer programs; and
one or more processors communicatively coupled to the memory,
wherein the one or more computer programs include computer-executable instructions that, when executed by the one or more processors individually or collectively, cause the system to:
detect at least one of a current display position and a current style of at least one widget displayed on the wallpaper,
detect one or more objects present in a plurality of regions of the wallpaper,
estimate one or more changes required in the at least one widget based on at least one of the current display position and the current style, and further based on the one or more objects, and
alter, based on the estimated one or more changes, at least one of the current display position and the current style of the at least one widget.

16. The system of claim 15,
wherein the one or more objects are detected using a scene graph, and
wherein the scene graph represents the one or more objects and a first relationship among the one or more objects determined based on an interaction among the one or more objects.

17. The system of claim 16, wherein the one or more computer programs further include computer-executable instructions that, when executed by the one or more processors individually or collectively, cause the system to, in response to estimating the one or more required changes:
identifying at least one relevant region from the plurality of regions for positioning the at least one widget based on a size of the plurality of regions, a relevance of the plurality of regions, and a composition property map associated with the plurality of regions of the wallpaper, wherein the composition property map is indicative of the one or more properties associated with the plurality of regions; and
obtaining a list of relevant widget styles based on corresponding one or more properties associated with the at least one relevant region.

18. The system of claim 17, wherein the composition property map is generated based on the one or more objects, the first relationship among the one or more objects, and a determination of a segmentation map and a depth map of the wallpaper.

19. The system of claim 15, further comprising:
a display communicatively coupled to the one or more processors and configured to display the wallpaper,
wherein the one or more computer programs further include computer-executable instructions that, when executed by the one or more processors individually or collectively, cause the system to:
generate an altered widget based on the at least one of the altered current display position and altered style, and
generate one or more widget compositions including the altered widget.

20. One or more non-transitory computer-readable storage media storing one or more computer programs including computer-executable instructions that, when executed by one or more processors of an electronic device individually or collectively, cause the electronic device to perform operations, the operations comprising:
detecting at least one of a current display position and a current style of at least one widget displayed on a wallpaper;
detecting one or more objects present in a plurality of regions of the wallpaper;
estimating one or more changes required in the at least one widget based on at least one of the current display position and the current style, and further based on the one or more objects; and
altering, based on the estimated one or more changes, at least one of the current display position and the current style of the at least one widget.
